(19) United States
(12) Patent Application Publication
(10) Pub. No.: US 2013/0290004 A1
(43) Pub. Date: Oct. 31, 2013

(54) RESPITE CARE COORDINATION SYSTEM

(71) Applicant: Kathleen A. Stauffer, Mystic, CT (US)

(72) Inventor: Kathleen A. Stauffer, Mystic, CT (US)

(21) Appl. No.: 13/456,766

(22) Filed: Apr. 26, 2012

(51) Int. Cl. G06Q 50/22

(52) U.S. Cl. 705/2

(57) ABSTRACT

A respite care coordination system permits the exchange of respite care for connecting primary care providers with respite care providers. Respite care providers access the respite care coordination system to enter information regarding themselves and their availability to perform respite care services. Primary care providers utilize the respite care coordination system to determine the availability of respite care services and the proper procedure to communicate with the selected respite care provider.

### BACKGROUND

The care of individuals with disabilities can be an incredibly stressful and wearing situation. In some situations, the care of an individual by a primary care giver, typically a family member, can involve providing twenty-four seven care. In those situations, the primary care giver may be unable to let their guard down for even a small amount of personal time. The situations can be so stressful that the likelihood of divorce increases, family stress increases, and the overall personal wellness for all concerned suffers. Accordingly, one of the biggest and greatest needs among families is respite support.

Despite the need for respite care, government funding for respite care is continually decreasing. As a result, families may resort to hiring a staffing company or a person from an advertisement to provide the service. Unfortunately, staffing companies can charge immensely for such specialized services, which the family may or may not be able to afford. Using individuals from advertisements can also be problematic because the family may only have a limited knowledge of the individual's background and qualifications. As a result, primary care providers and their families may choose to forgo receiving respite care services.

### SUMMARY

In general terms, the present disclosure is directed to a respite care coordination system for coordinating respite care services between respite care providers and primary care providers. Various aspects are described in this disclosure, which include, but are not limited to, the following aspects.

One aspect of the respite care coordination system permits the exchange of respite care related information among a primary care provider, an organizer, and a respite care provider. The organizer utilizing the respite care coordination system provides a respite care database for connecting primary care providers with respite care providers. Respite care providers and primary care providers are able to apply for access to the respite care coordination system. The respite care providers enter information regarding themselves and their availability to perform respite care services is entered by the database administrator. Primary care providers are able to utilize the respite care coordination system to determine the availability of respite care services. Upon selection of a particular respite care provider, the primary caregiver communicates with the selected respite care provider.

One aspect of the respite care coordination system includes a database of respite care providers authorized to provide respite care services. The database stores data in one or more computer readable storage device(s) including contact information for the respite care provider and available times that the respite care provider is available to provide respite care. A server computing device programmed to retrieve digital data from the database and to generate and transfer digital data across a network to user computing devices associated with users, wherein the digital data is configured to be interpreted by the user computing devices to display to the users an interactive web site. The web site providing accessibility to search the available times that respite care services are available.

Another aspect of the respite care coordination system includes a respite care database adapted to store data in one or more computer readable storage devices. The data including contact information for a respite care provider and available times that the respite care provider is available to provide respite care. A server computing device programmed to retrieve digital data from the database and to generate and transfer digital data across a network to user computing devices associated with users, wherein the digital data is configured to be interpreted by the user computing devices to display to the users an interactive web site. The web site prompting the respite care provider to enter their contact information and available times that the respite care provider is available to provide respite care services.

Another aspect of the respite care coordination system is direct to at least one computing device including at least one processing device and at least one computer readable storage device comprising data instructions. When executed by the computing device cause the at least one computing device to generate a respite care database; a registration engine that prompts a user for information relating to the user, receives the incoming data from the user and extracts the user information from the incoming data, identifies whether the user is a respite care provider, identifies the user information and its respective categories, stores the categorized user information in the respite care database; a scheduling engine that prompts the respite care provider for availability of information relating to the respite care provider's availability to perform respite care services, receives the incoming data from the user and extracts the availability information from the incoming data, identifying the availability information and its respective categories, stores the categorized availability information in the respite care database; a membership engine that receives login credentials from the user, retrieves the user information, determines whether the primary care provider is an active member of the respite care coordination system, and permitting access to the respite care connection system if the primary care provider is an active or denying access to the respite care connection system if the primary care provider is inactive; and a respite care connection engine that that prompts the user for search parameters for respite care services, receives the incoming data from the user and determines the category of the search parameter, query the respite care database for the search parameter, and presents the results to the user.

### BRIEF DESCRIPTION OF THE DRAWINGS

FIG. 1 is schematic block diagram illustrating an exemplary respite care coordination system.

FIG. 2 is a schematic block diagram illustrating an example of the respite care coordination system, shown in FIG. 1.

FIG. 3 illustrates an exemplary architecture of a computing device.

FIG. 4 is a block diagram illustrating an example of the respite care database.

FIG. 5 is a flow chart illustrating exemplary operations performed by the registration engine.

FIG. 6 is a flow chart illustrating exemplary operations performed by the scheduling engine.

FIG. 7 is a flow chart illustrating exemplary operations performed by the membership engine.

FIG. 8 is a flow chart illustrating exemplary operations performed by the respite care connector engine.

FIG. 9 is a flow chart illustrating exemplary operations performed by the search engine.

FIG. 10 is a screenshot of an example login page of the respite care coordination system.

FIG. 11 is screenshot of the example respite care connector engine page of the respite care coordination system for searching a particular time period.

FIG. 12 is a screenshot of the example results page for searching a particular time period in the respite care coordination system.

FIG. 13 is screenshot of the example respite care connector engine page of the respite care coordination system for searching a particular weekday.

FIG. 14 is another screenshot of the example results page for searching a particular weekday in the respite care coordination system.

FIG. 15 is screenshot of the example respite care connector engine page of the respite care coordination system for searching a particular respite care provider.

FIG. 16 is another screenshot of the example results page for searching a particular respite care provider in the respite care coordination system.

FIG. 17 is schematic block diagram illustrating an exemplary respite care coordination system to service multiple regions.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

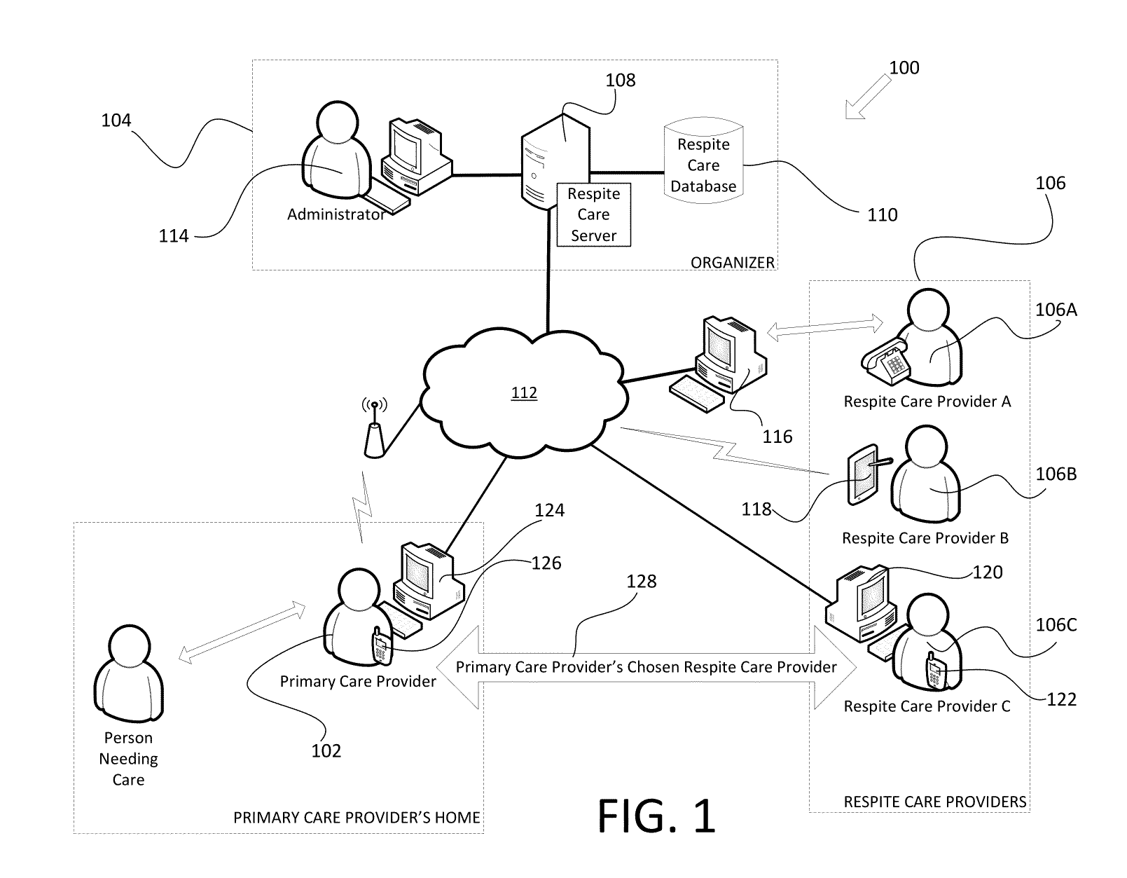

FIG. 1 is schematic block diagram illustrating an exemplary respite care coordination system 100. In the example embodiment, the respite care coordination system permits 100 the exchange of respite care related information among a primary care provider 102, an organizer 104, and respite care providers 106.

In the example respite care coordination system 100, the organizer 104 provides a respite care server 108 (i.e., a computing device) and a respite care database 110 (i.e., a data storage device), which are in data communication with a data communication network 112. The respite care database 110 stores respite care related information. In some embodiments, the organizer 104 further includes an administrator 114 to update respite information, certify users, or to control access to the respite care server 108. Further, in some embodiments, the organizer may be an organization that employs certain respite care providers and certifies that respite care providers have attending proper training courses and that the respite care providers have passed a drug test and a background check.

Each respite care provider 106A, 106B, 106C communicates with the respite care server 108 to exchange respite care information related to the respective respite care provider 106. Typically, each respite care provider 106 has access at least one computing device 116, 118, 120, 122 adapted to communicate with the respite care server 108. The one or more possible computing devices are represented by the computing devices 116, 118, 120, 122. In the illustrated embodiment, respite care providers 106 utilize computers, tablets, personal computers, PDA, or smart phones to interact with the respite care server 108. The computing devices can communicate directly with the respite care server 108 or communicate with another data communication network 112, such as the Internet, a local area network, or other data communication network, in which data can be communicated with the respite care server 108. Further, in some embodiments, there may be additional intermediary computing devices (such as those operated by third party services that participate in the data communications within the respite care coordination system 100).

Likewise, the primary care provider 102 typically has access to at least one or more computing devices 124, 126 adapted to communicate with the respite care server 108 to exchange respite care information. In some embodiments, respite care providers 106 utilize a personal computer, tablet PC, PDA, or smart phone to interact with the respite care server 108. In the example embodiment, the primary care provider 102 communicates with the respite care server 108 to receive information relating to the respite care providers 106. For example, in one embodiment, the primary care provider 102 utilizes the respite care coordination system 100 to determine the available times that respite care providers 106 are available to perform respite care services.

Upon the primary care provider 102 selecting a particular respite care provider 106, the primary care provider 102 communicates with the selected respite care provider 106. In the illustrated embodiment, the primary care provider 102 communicates directly with the respite care provider 106 via a communication device, such as telephone, smartphone, or a computer. In other embodiments, the primary care provider 102 may contact, reserve, or schedule a time with the respite care provider 106 via the respite care coordination system 100.

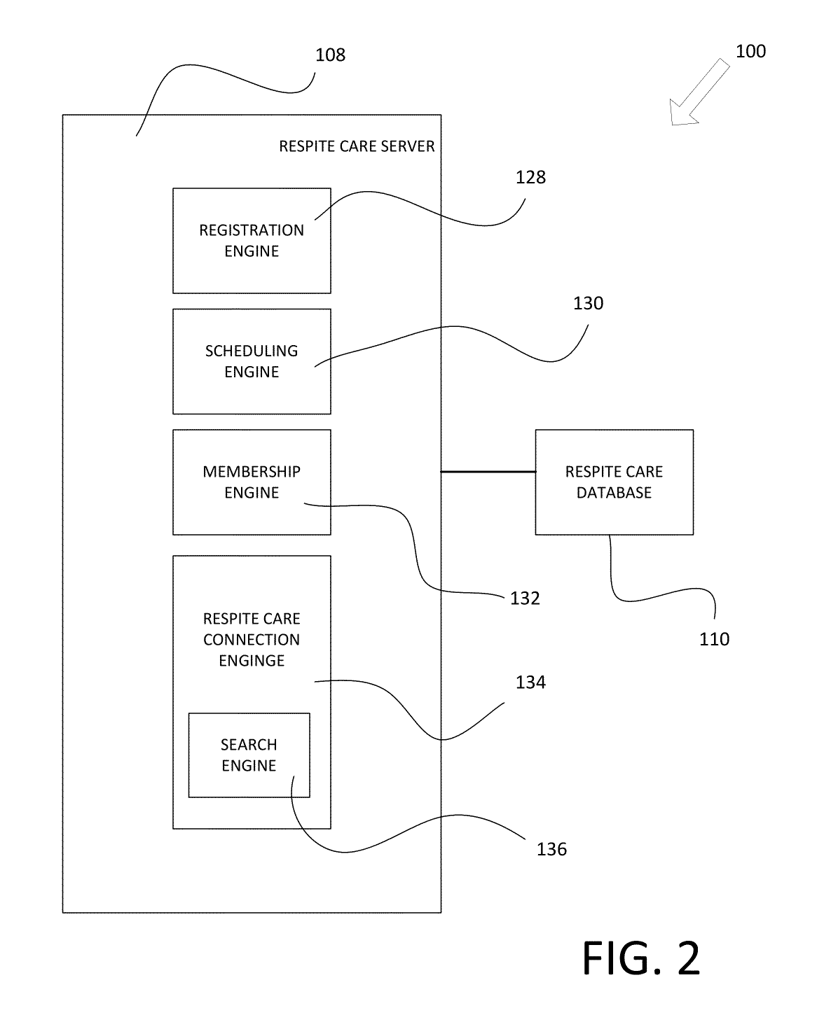

FIG. 2 is a schematic block diagram illustrating an example of the respite care coordination system 100, shown in FIG. 1. The respite care coordination system 100 includes a computing device 108 and a data storage device 110. In the example embodiment, the computing device 108 and a data storage device 110 are shown as the respite care server and the respite care database, respectfully.

The data storage device 110 can be a part of the computing device 108 (such as memory or secondary storage device, shown in FIG. 2), or can be a separate data storage device. For example, the data storage device 110 can be a separate database, which can itself include one or more computing devices, in some embodiments. In any event, the data storage device 110 includes one or more computer readable storage devices that store digital data. Examples of computer readable storage devices are described herein.

The computing device 108 includes one or more engines 128, 130, 132, 134, 136 that are executed by the computing device 108 to perform particular functions. In this example, the computing device 108 includes a registration engine 128, a scheduling engine 130, a membership engine 132, and a respite care connection engine 134 having a search engine 136. A brief exemplary description of each engine is provided below, while a more detailed explanation and additional examples are provided herein.

The registration engine 128 manages the enrollment of users to the computing device 108. For example, the registration engine 128 prompts primary care providers 102 and respite care providers 106 to provide user information, receives the user information, extracts the user information, and saves the user information in a common format.

The scheduling engine 130 manages the availability information for each of the respite care providers 106. For example, the scheduling engine 130 receives each respite care provider's 106 scheduling information, extracts the scheduling information, and saves the scheduling information in a common format.

The membership engine 132 manages the membership status of users to control access to the respite care coordination system 100.

The respite care connection engine 134 performs the operations necessary to connect primary care provider 102 with the respite care provider 106. For example, the respite care connection engine 134 receives respite care search parameter from the primary care providers 102. The respite care connection engine 134 includes a search engine 136 that searches through the data storage device 110 to identify information responsive to the search parameter.

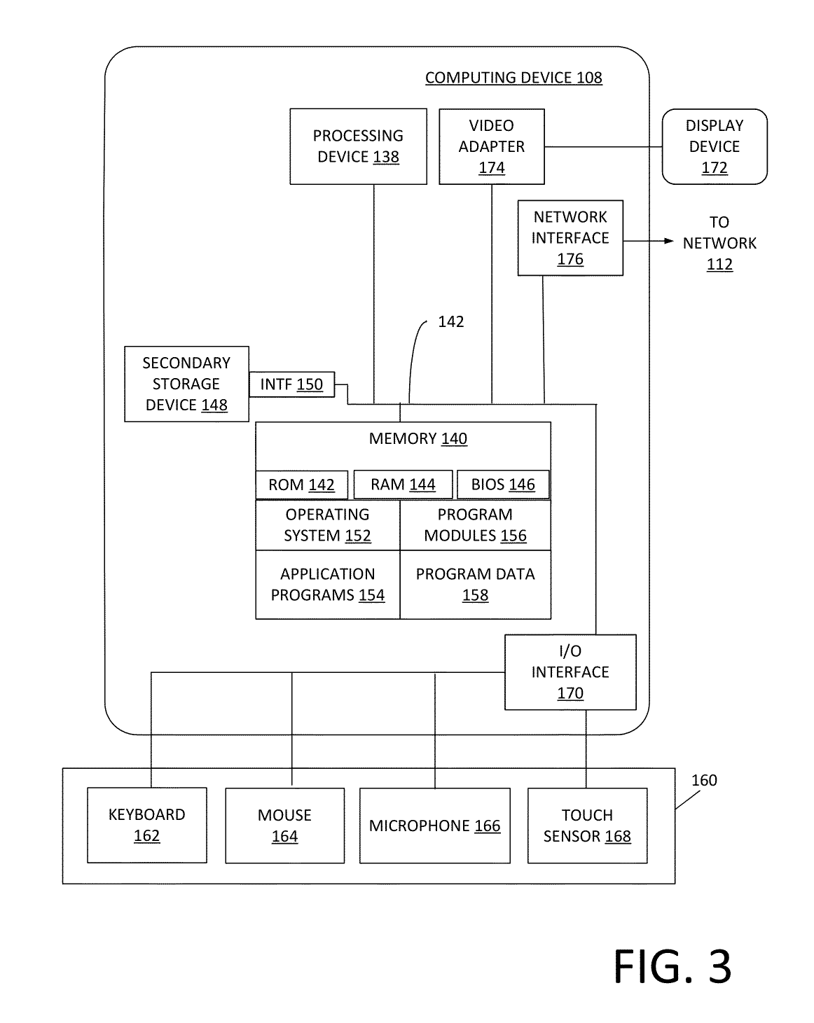

FIG. 3 illustrates an exemplary architecture of a computing device 108 that can be used to implement aspects of the present disclosure, including any of the plurality of computing devices 108, 116, 118, 120, 122, 124, 126. The computing device 108 illustrated in FIG. 2 can be used to execute the operating system, application programs, and software modules (including the software engines) described herein. By way of example, the computing device will be described below as an example of the respite care server 108. To avoid undue repetition, this description of the computing device 108 will not be separately repeated herein for each of the other computing devices, including 116, 118, 120, 122, 124, 126, but such devices can also be configured as illustrated and described with reference to FIG. 3.

The computing device 108 includes, in some embodiments, at least one processing device 138, such as a central processing unit (CPU). A variety of processing devices are available from a variety of manufacturers, for example, Intel or Advanced Micro Devices. In this example, the computing device 108 also includes a system memory 140, and a system bus 142 that couples various system components including the system memory 140 to the processing device 138. The system bus 142 is one of any number of types of bus structures including a memory bus, or memory controller; a peripheral bus; and a local bus using any of a variety of bus architectures.

Examples of computing devices suitable for the computing device 108 include a desktop computer, a laptop computer, a tablet computer, a mobile computing device (such as a smart phone, an iPod® or iPad® mobile digital device, or other mobile devices), or other devices configured to process digital instructions.

The system memory 140 includes read only memory 142 and random access memory 144. A basic input/output system 146 containing the basic routines that act to transfer information within computing device 108, such as during start up, is typically stored in the read only memory 142.

The computing device 108 also includes a secondary storage device 148 in some embodiments, such as a hard disk drive, for storing digital data. The secondary storage device 148 is connected to the system bus 142 by a secondary storage interface 150. The secondary storage devices 148 and their associated computer readable media provide nonvolatile storage of computer readable instructions (including application programs and program modules), data structures, and other data for the computing device 108.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage 148 or memory 140, including an operating system 152, one or more application programs 154, other program modules 156 (such as the registration engine 128, a scheduling engine 130, a membership engine 132, a respite care connection engine 134, and search engine 136 described herein), and program data 158. The computing device 108 can utilize any suitable operating system, such as Microsoft Windows™, Google Chrome™, Apple OS, and any other operating system suitable for a computing device. Other examples can include Microsoft, Google, or Apple operating systems, or any other suitable operating system used in tablet computing devices.

In some embodiments, a user provides inputs to the computing device 108 through one or more input devices 160. Examples of input devices 160 include a keyboard 162, mouse 164, microphone 166, and touch sensor 168 (such as a touchpad or touch sensitive display). Other embodiments include other input devices 160. The input devices are often connected to the processing device 138 through an input/output interface 170 that is coupled to the system bus 142. These input devices 160 can be connected by any number of input/output interfaces, such as a parallel port, serial port, game port, or a universal serial bus. Wireless communication between input devices and the interface 170 is possible as well, and includes infrared, BLUETOOTH® wireless technology, 802.11 a/b/g/n, cellular, or other radio frequency communication systems in some possible embodiments.

In this example embodiment, a display device 172, such as a monitor, liquid crystal display device, projector, or touch sensitive display device, is also connected to the system bus 142 via an interface, such as a video adapter 174. In addition to the display device 172, the computing device 108 can include various other peripheral devices (not shown), such as speakers or a printer.

When used in a local area networking environment or a wide area networking environment (such as the Internet), the computing device 108 is typically connected to the network 112 through a network interface 176, such as an Ethernet interface. Other possible embodiments use other communication devices. For example, some embodiments of the computing device 108 include a modem for communicating across the network.

The computing device 108 typically includes at least some form of computer readable media. Computer readable media includes any available media that can be accessed by the computing device 108. By way of example, computer readable media include computer readable storage media and computer readable communication media.

Computer readable storage media includes volatile and nonvolatile, removable and non-removable media implemented in any device configured to store information such as computer readable instructions, data structures, program modules or other data.

Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 108.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device 108 illustrated in FIG. 3 is also an example of programmable electronics, which may include one or more such computing devices, and when multiple computing devices are included, such computing devices can be coupled together with a suitable data communication network so as to collectively perform the various functions, methods, or operations disclosed herein.

In various alternate embodiments, the respite care coordination system 100 is implemented on mobile devices such as PDAs, smartphones, or tablet computing devices. In such embodiments, the program modules or application modules on the mobile device include a local application that operates in conjunction with the respite care server 108 to prompt the user for input, search the database, and display results.

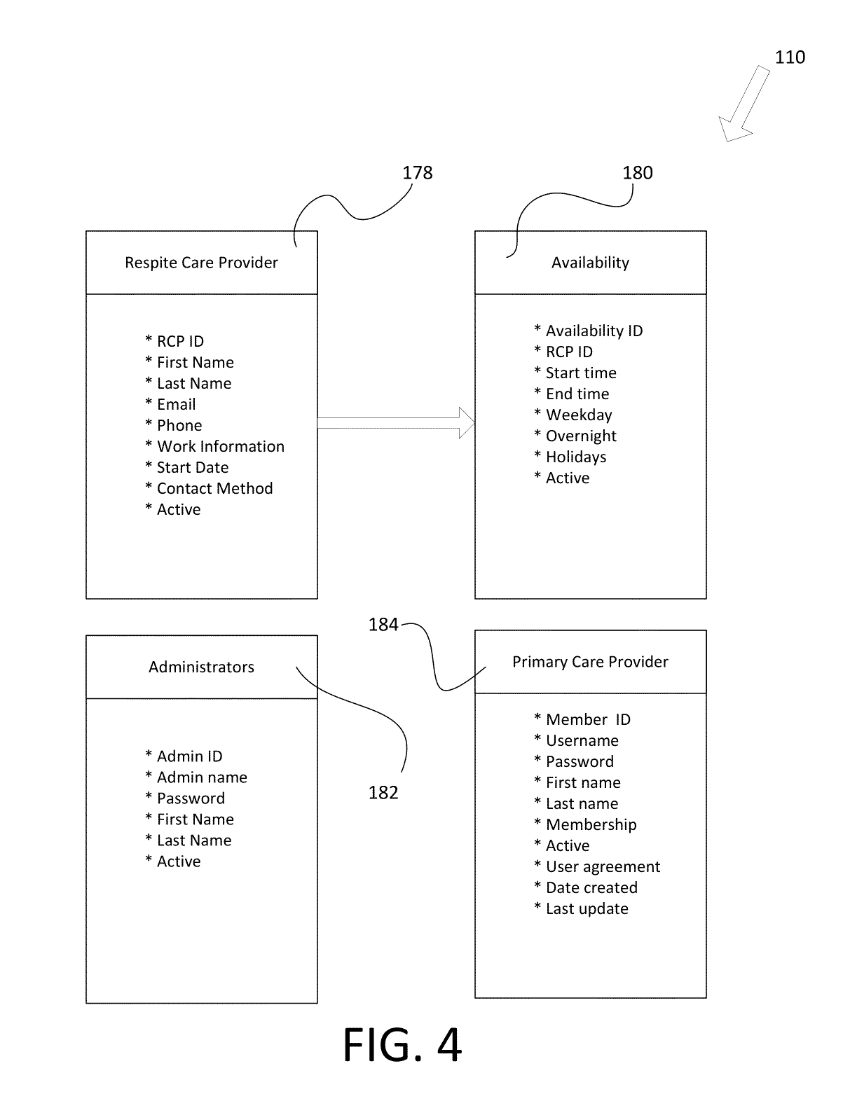

FIG. 4 is a block diagram illustrating an example of the respite care database 110. In this example, the respite care database 110 includes a respite care provider information 178, availability information 180, administrator information 182, and primary care provider information 184.

The respite care provider information 178 includes contact information and other selected information relating to the respite care provider 106. For example, in the illustrated embodiment, the respite care provider information 178 includes the respite care provider's respective ID, name, email, phone information, certifications, their work information, start date, preferred method of contact, and whether they are currently active in the respite care coordination system 100.

The availability information 180 includes scheduling information for the respective respite care provider. For example, in the illustrated embodiment, the availability information 180 includes the respite care provider's respective ID, the start and end times the respite care provider is available for shifts, weekdays the respite care provider is available, whether the respite care provider is available for overnight care or holidays, and whether they are active in the respite care coordination system 100.

The administrator information 182 includes administrator's credentials for managing the information on the respite care coordination system 100 and user's accessibility to the respite care information. In the illustrated embodiment, the administrator information 182 includes the administrator's respective name and ID, password, and whether they are active in the respite care coordination system 100.

The primary care provider information 184 includes contact information and other selected information relating to the primary care provider. For example, in the illustrated embodiment, the primary care provider information 184 includes the primary care provider's respective ID, name, membership information, whether the primary care provider has agreed to the user agreement, the account creation and last update dates, and whether they are currently active in the respite care coordination system 100.

The respite care server 108 manages the availability of the respite care database 110 to users. In certain embodiments, the respite care server 108 may allow for greater accessibility of editing information than in others. For example, in one embodiment, the respite care database 110 is configured for only permitting the administrator 112 to populate the respite care provider information 178, availability information 180, administrator information 182, and primary care provider information 184. In this example, the organizer 104 would be able to verify the accuracy of the information on the database and could continually update whether the respite care provider is eligible to provide services. In an alternate embodiment, the respite care database 110 may permit respite care providers 106 and primary care providers 102 to enter selected information into the respite care database 110, while the administrator 114 is permitted control over the user accounts and the information provided in the respite care provider information 178, availability information 180, administrator information 182, and primary care provider information 184. In yet another embodiment, the organizer 104 may openly provide access to the respite care database 110 after the user meets certain requirements.

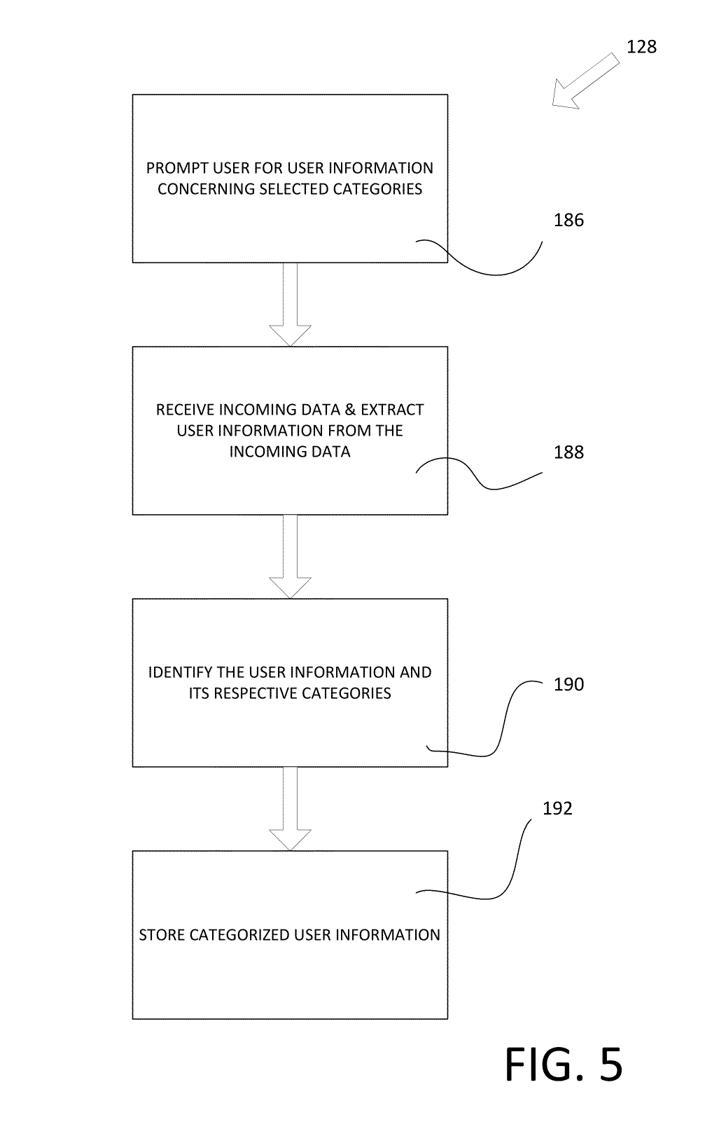

FIG. 5 is a flow chart illustrating exemplary operations performed by the registration engine 128. FIG. 5 also illustrates an exemplary method of a user populating the respite care database 110 with the respite care provider information 178 or the primary care provider information 184 discussed in FIG. 4. In other embodiments, the administrator 114 may populate the respite care database 100 with the user's respective information. As discussed generally above, the registration engine 128 manages the enrollment of users to the computing device 108. The users typically include the respite care providers 106 and the primary care providers 102. It should be noted that while the primary care providers 102 are discussed in this embodiment, the user could also be another member of the family which is seeking respite care for an individual, the person in need of care, or another person.

The method begins by performing an operation 186 to prompt the user for user information. For example, for a respite care provider 106, the registration engine 128 prompts the user to enter information relating to categories found in the respite care provider information 178 in the respite care database 110, including their respite care provider's ID, name, email, phone information, certifications, their work information, start date, and preferred method of contact. In another example, for the primary care provider 102, the registration engine prompts the user to enter information relating to categories found in the primary care provider information 184 in the respite care database 110, including the primary care provider's respective ID and name. The registration engine operation 188 receives the incoming data from the user and extracts the user information from the incoming data. Once the user information has been extracted, the operation 190 identifies the user information and its respective categories. Operation 192 stores the categorized user information in the respite care database. For example, in one embodiment, the user information for the respite care provider 106 would be saved in the respite care provider information 178 in the respite care database 110.

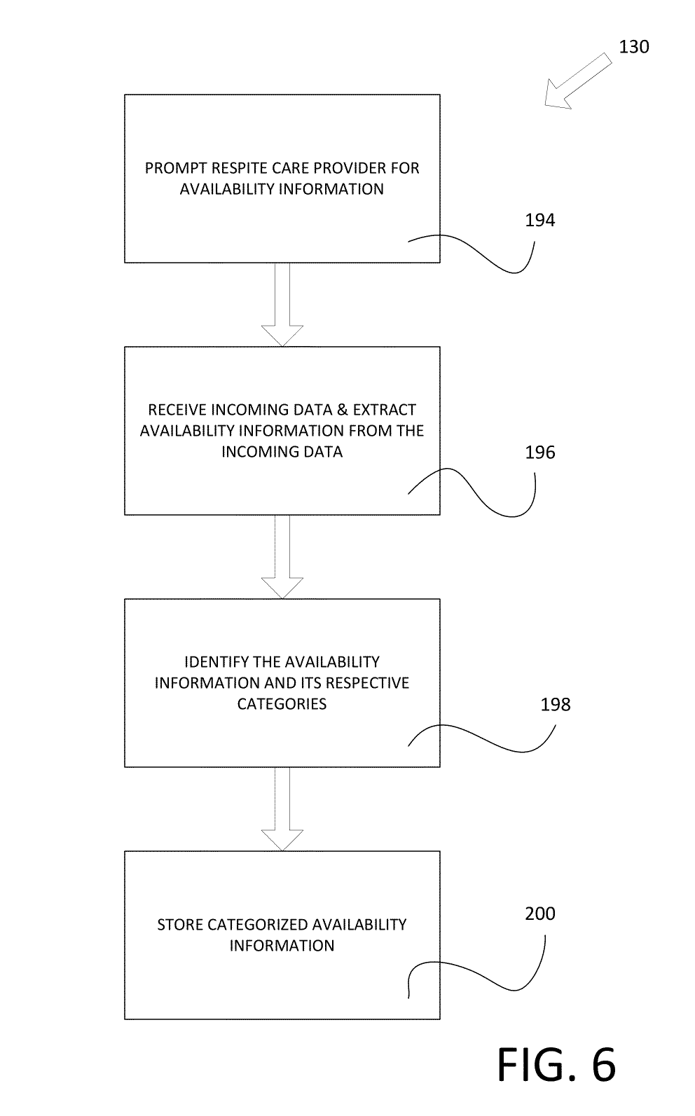

FIG. 6 is a flow chart illustrating exemplary operations performed by the scheduling engine 130. FIG. 6 also illustrates an exemplary method of a user populating the respite care database 110 with the availability information 180. In other embodiments, the administrator 114 may populate the respite care database 100 with the availability information. As discussed generally above, the scheduling engine 130 manages the availability information 180 for each of the respite care providers 106.

The method begins by performing an operation 194 to prompt the user for availability information 180. For example, for a respite care provider 106, the scheduling engine 130 prompts the user to enter availability information 180 relating to the respite care provider's availability to perform respite care services. The scheduling engine operation 196 receives the incoming data from the user and extracts the availability information from the incoming data. Once the availability information has been extracted, the scheduling engine operation 198 identifies the availability information and its respective categories. Operation 200 stores the categorized availability information in the respite care database. For example, in one embodiment, the availability information for the respite care provider 106 would be saved in their respective availability information 180 for the respite care provider information 178 in the respite care database 110.

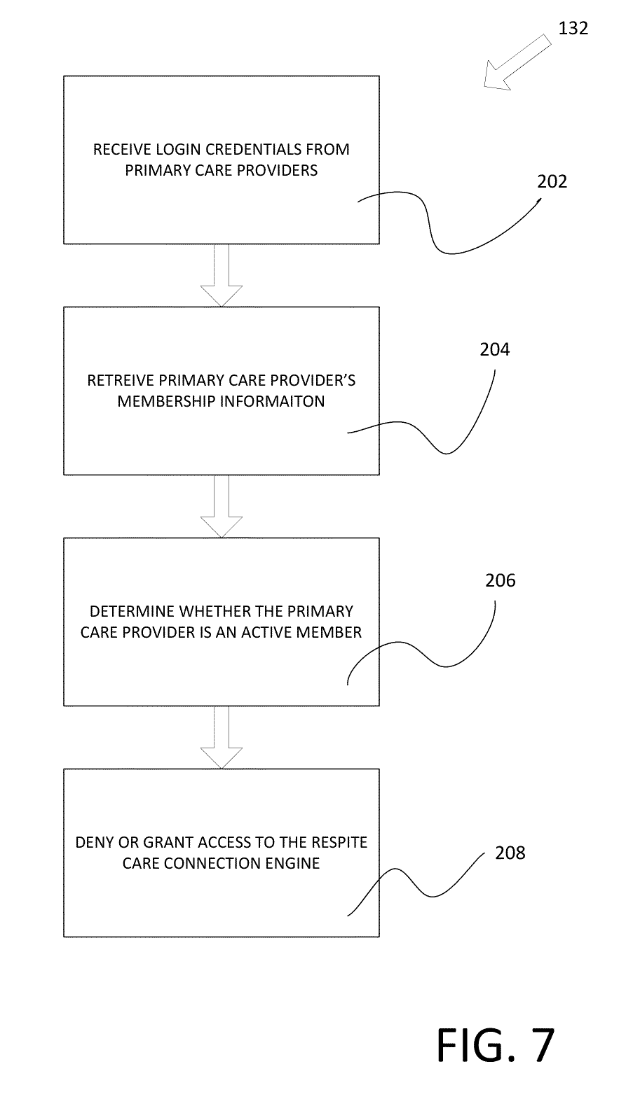

FIG. 7 is a flow chart illustrating exemplary operations performed by the membership engine 132. FIG. 7 also illustrates an exemplary method of evaluating user information to manage accessibility to the respite care coordination system 100. As discussed generally above, the membership engine 132 manages user's accessibility of the respite care coordination system 100 based upon the user information.

The method begins an operation 202 of receiving login credentials from the primary care provider 102, such as the username and password. The membership engine operation 204 retrieves the primary care provider information relating to their membership. The membership engine operation 206 determines whether the primary care provider 102 is an active member of the respite care coordination system 100. Upon verification that the primary care provider 102 is an active member, the membership engine operation 208 permits access to the respite care connection engine 134. If the primary care provider 102 is not an active member, the primary care provider 102 is prompted to renew their membership for the respite care coordination system 100.

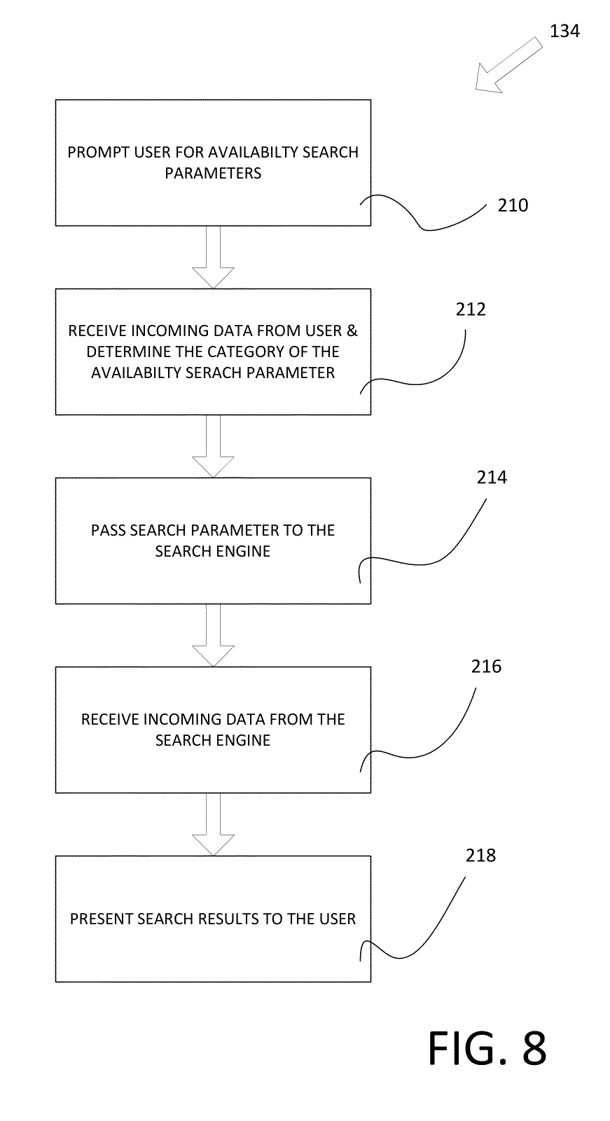

FIG. 8 is a flow chart illustrating exemplary operations performed by the respite care connection engine 134. FIG. 8 also illustrates an exemplary method of searching the respite care database 110 for the respite care providers' 106 availability to provide respite care services. As discussed generally above, the respite care connection engine 134 performs the operations necessary to connect a primary care provider 102 with the respite care provider 106.

The method begins by performing an operation 210 to prompt the user for availability search parameters. The respite care connection engine 134 operation 212 receives the incoming data from the user and determines the category of the availability search parameter. For example, in one embodiment, the availability search parameters include selected day and a specified start time. In another embodiment, the availability search parameters include a selected day. In yet another embodiment, the availability search parameters include the name of a particular respite care provider 106.

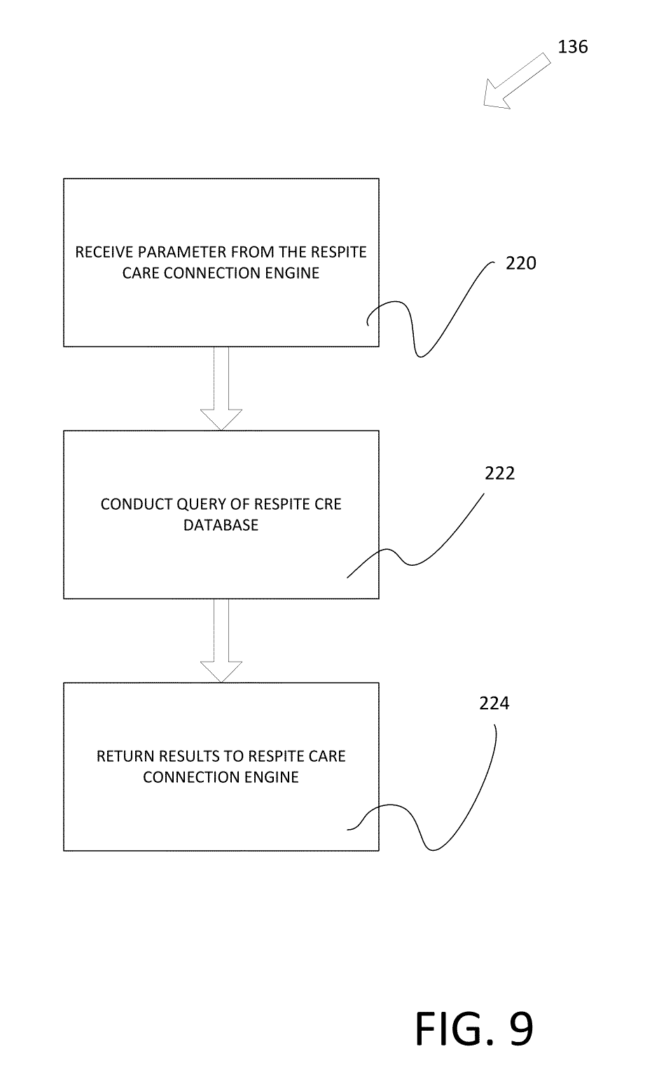

The respite care connector utilizes a search engine, discussed in further detail with reference to FIG. 9, to conduct a search of the respite care database 110. The respite care connector engine operation 214 passes the search parameters to the search engine 136 to query the respite care database. Upon the completion of the search, the respite care connector engine operation 216 receives incoming data from the search engine 136 relating to the availability search parameters. The respite care connector engine operation 218 presents the results for the search parameter to the user.

FIG. 9 is a flow chart illustrating exemplary operations performed by the search engine 136. As discussed generally above, the search engine 136 searches through the respite care database 110 to identify information responsive to the availability search parameter. The method begins by performing an operation 220 to receive the search parameter from the respite care connection engine 134 to query the respite care database 110. The search engine operation 222 conducts a search of the respite care database 110 that matches the query. The search engine operation 224 passes the results to the respite care connection engine 234.

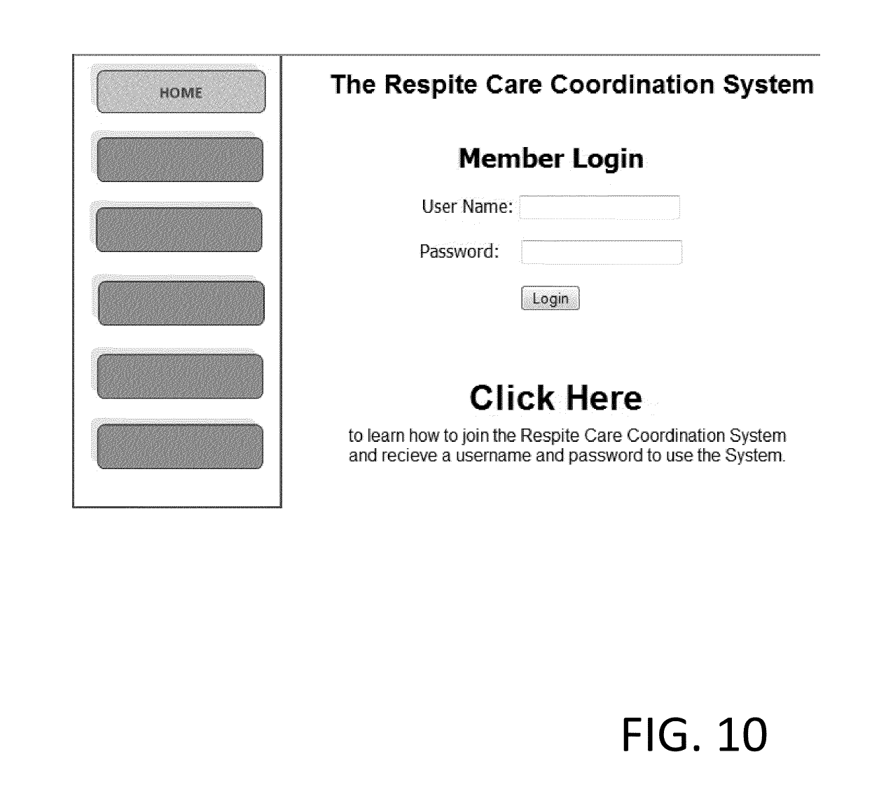

FIG. 10 is a screenshot of an example login page of the respite care coordination system 100 shown on a user interface. As discussed in FIG. 7, in the illustrated embodiment, the user is prompted for their username and password. The membership engine receives the username and password and determines whether the user is an active member of the respite care coordination system 100. Upon verification that the user is an active member, the membership engine 132 permits access to the respite care connection engine. If the primary care provider 102 is not an active member, the primary care provider 102 is prompted to renew their membership for the respite care coordination system 100.

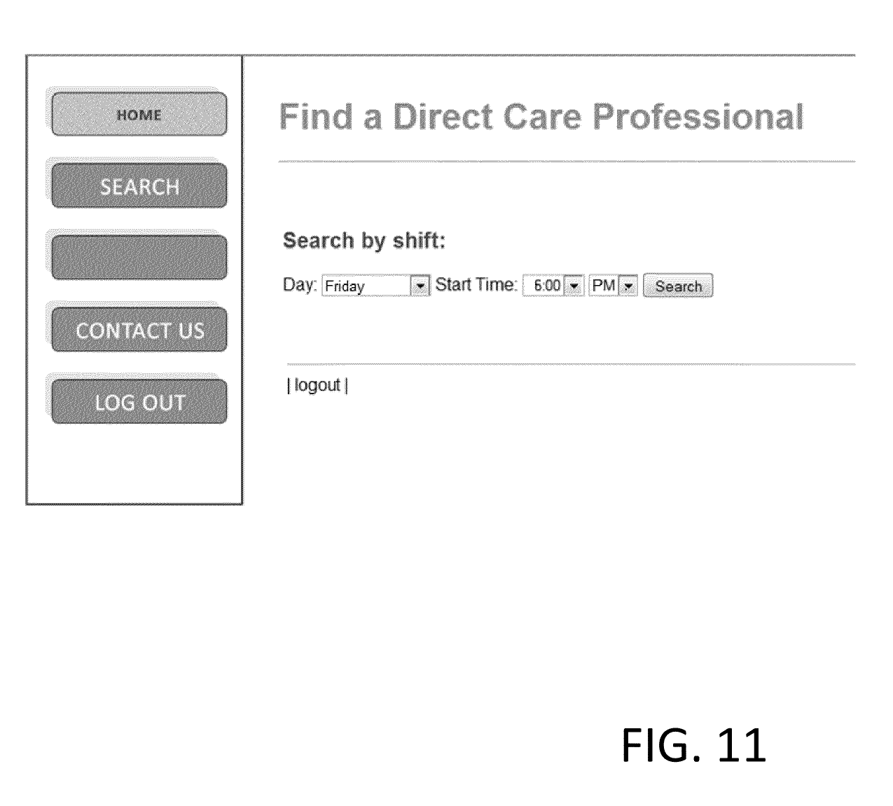

FIG. 11 is screenshot of the example respite care connector engine 234 of the respite care coordination system 100 shown on a user interface. In the example embodiment, the user interface display prompts the user to input the search parameters by using one of the three methods. Specifically, the user can search for a respite care provider's availability by searching for a particular shift, by day of the week, or by the respite care provider's name. In the illustrated embodiment, FIG. 11 shows searching for a particular shift. For example, the shift starting at 6:00PM on Friday.

Upon receipt of the search parameter, the respite care connector utilizes the search engine 136 to query the respite care database 110 to identify information responsive to the search parameter. Upon the completion of the search, the respite care connection engine 134 receives incoming data from the search engine 136 relating to the primary care providers search parameters. The respite care connection engine 134 generates and displays the results for the search parameter.

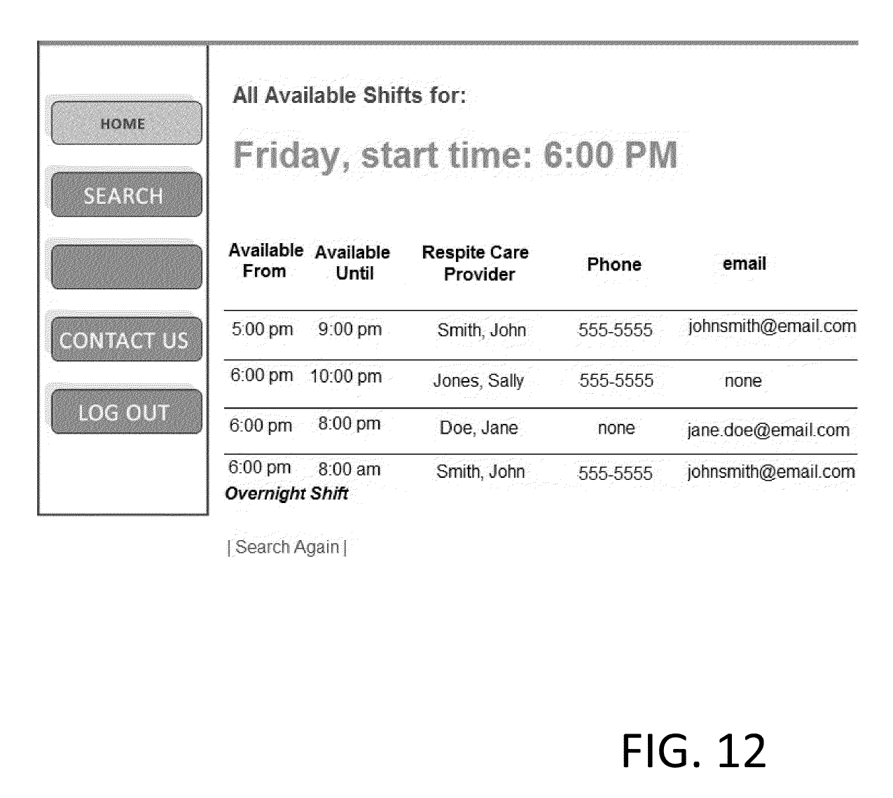

FIG. 12 is a screenshot of the example results page for searching a particular respite care provider in the respite care coordination system 100 discussed in FIG. 11. The results include the respite care providers name and contact information and their entire schedule of availability.

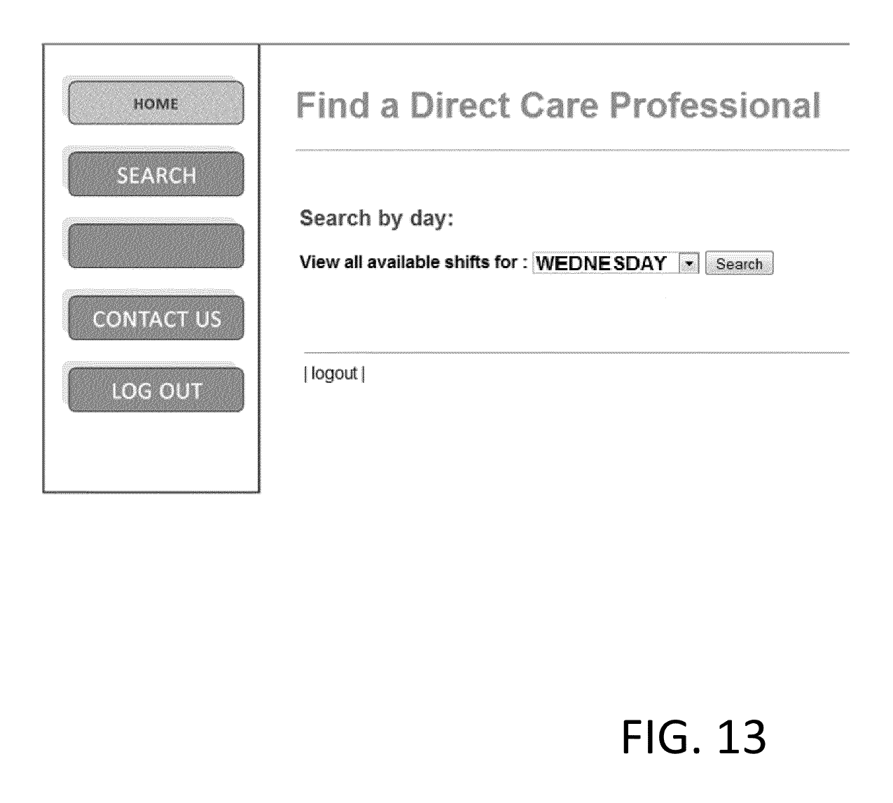

FIG. 13 is screenshot of the example respite care connector engine 234 of the respite care coordination system 100 shown on a user interface. In the example embodiment, the user interface display prompts the user to input the search parameters for a particular weekday. For example, the search parameters query all available shifts for Wednesday.

Upon receipt of the search parameter, the respite care connector utilizes the search engine 136 to query the respite care database 110 to identify information responsive to the search parameter. Upon the completion of the search, the respite care connection engine 134 receives incoming data from the search engine 136 relating to the primary care providers search parameters. The respite care connection engine 134 generates and displays the results for the search parameter.

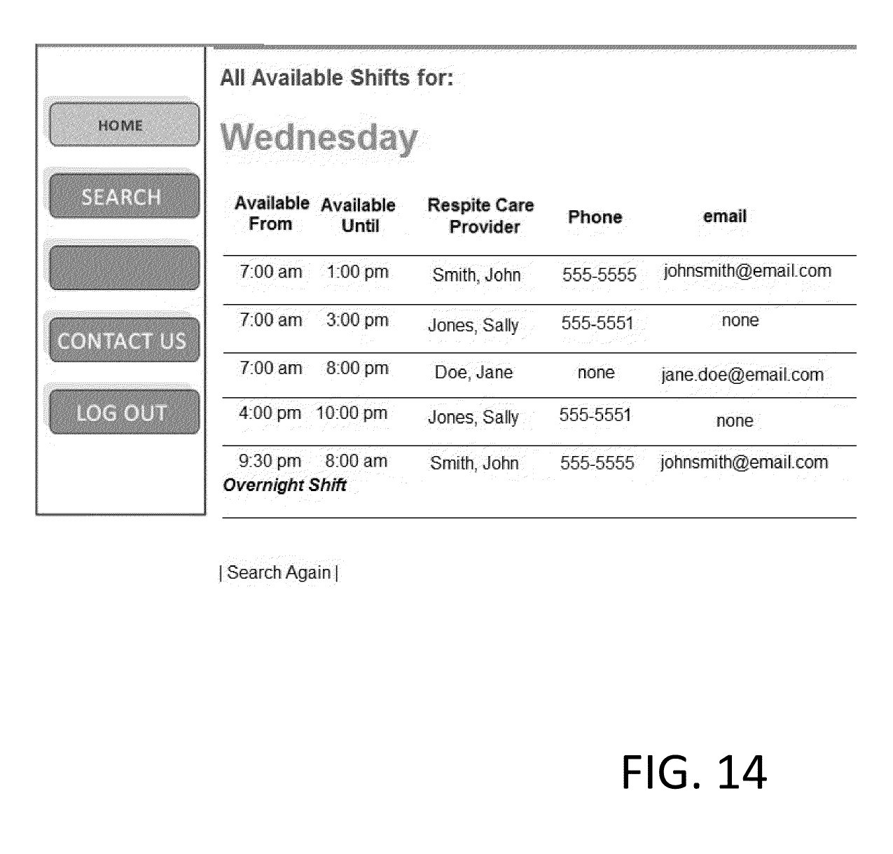

FIG. 14 is a screenshot of the example results page for searching a particular weekday in the respite care coordination system 100. The results include the start and stop times of availability throughout the day, the respite care provider's name, and the respite care providers contact information.

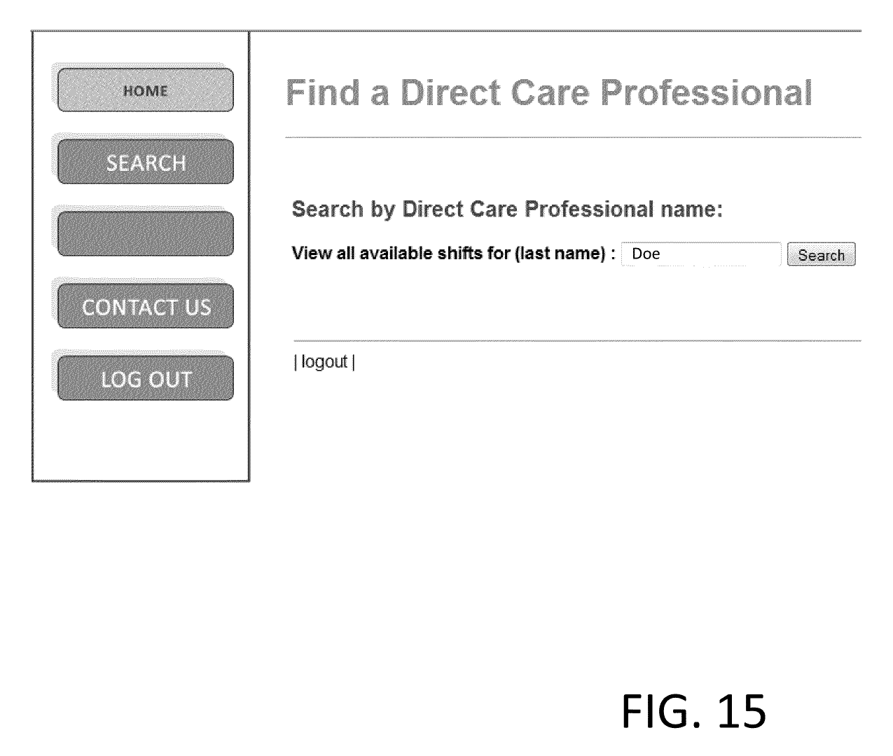

FIG. 15 is screenshot of the example respite care connector engine 234 of the respite care coordination system 100 shown on a user interface. In the example embodiment, the user interface display prompts the user to input the search parameters for a particular weekday. For example, the search parameters query all available shifts for a particular weekday.

Upon receipt of the search parameter, the respite care connector utilizes the search engine 136 to query the respite care database 110 to identify information responsive to the search parameter. Upon the completion of the search, the respite care connection engine 134 receives incoming data from the search engine 136 relating to the primary care providers search parameters. The respite care connection engine 134 generates and displays the results for the search parameter.

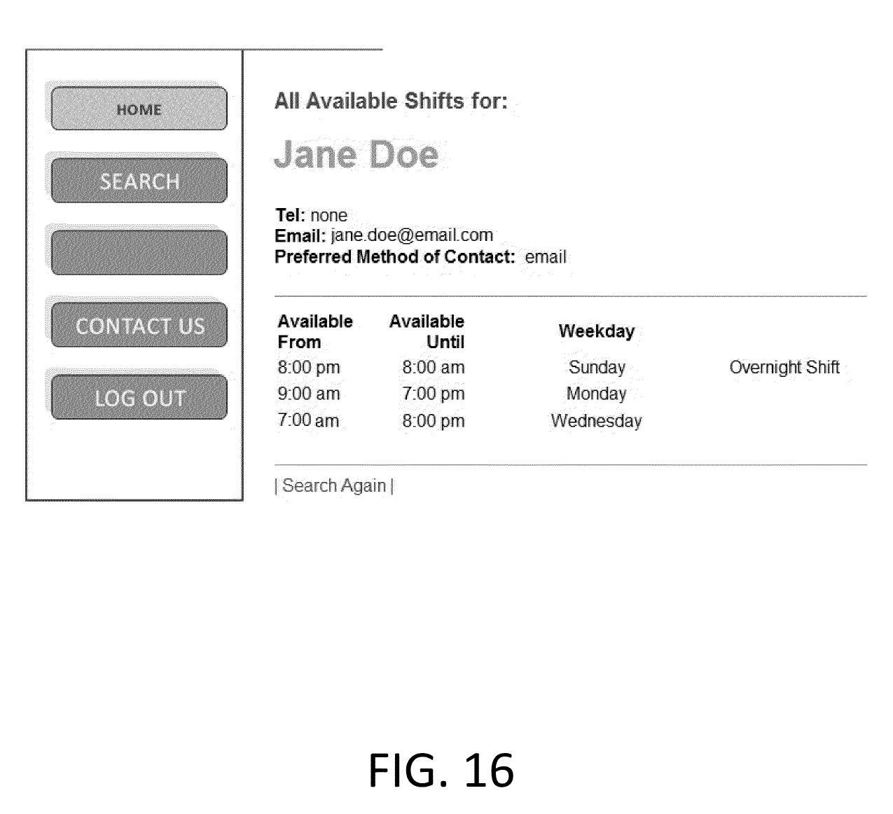

FIG. 16 is a screenshot of the example results page for searching a particular respite care provider 106 in the respite care coordination system 100. The results include the start and stop times of availability, the respite care provider's name, and the respite care providers contact information. For example, the search parameters query all available shifts for a particular respite care provider 106.

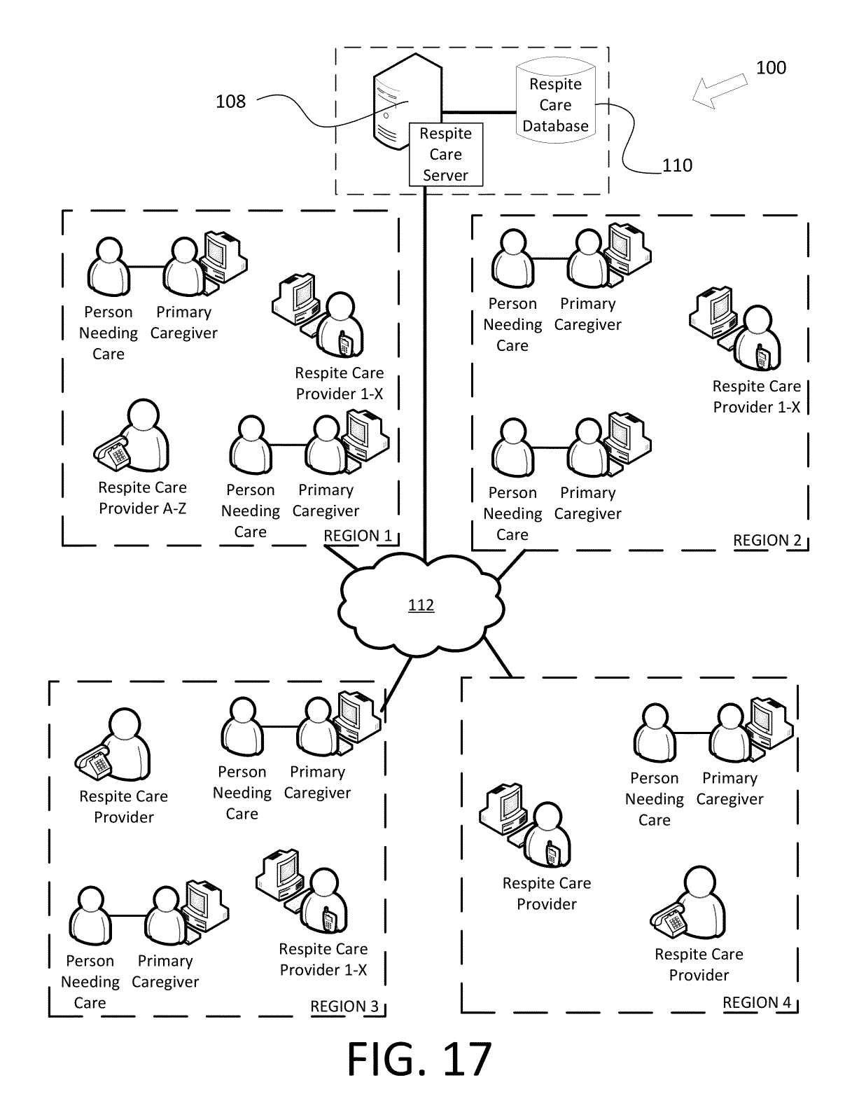

FIG. 17 is schematic block diagram illustrating an exemplary respite care coordination system 100 to service multiple regions. In the example embodiment, the respite care providers 106 and primary care providers 102 are divided into regions. These regions may represent cities, counties, or states where respite care providers are available and where primary care providers are seeking services. By separating the users into their respective regions, the respite care coordination system 100 can provide primary care providers 102 with information about respite care providers that are available in their respective region. In this way the respite care coordination system 100 does not provide information about respite care providers that are not available to provide respite care at the desired location.

In the foregoing description, reference is made to particular user interface displays generated by a server and displayed on a client computing device, such as through a browser software program. The user interfaces are provided as just one example of the many possible embodiments of such user interfaces, and embodiments including minor changes to such user interfaces are intended to be within the scope of this disclosure. As one example, the present disclosure makes reference to various web page controls, such as buttons, fields, selectable controls, check boxes, tabs, menus, and the like. Other embodiments can be made by selecting alternative web page controls. As another example, the present disclosure makes reference to various types of web page displays, such as windows, pages, lines, and the like. Other embodiments can be made by selecting alternative web page displays.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A respite care coordination system comprising:
a database of respite care providers authorized to provide respite care services, the database storing data in one or more computer readable storage devices, the data including:
contact information for the respite care provider; and
available times that the respite care provider is available to provide respite care; and
a server computing device programmed to retrieve digital data from the database and to generate and transfer digital data across a network to user computing devices associated with users, wherein the digital data is configured to be interpreted by the user computing devices to display to the users an interactive web site, the web site providing accessibility to search the available times that respite care services are available.

2. The respite care coordination system of claim 1 wherein the respite care coordination system is managed by an organizer that certifies the respite care providers.

3. The respite care coordination system of claim 1 wherein the organizer certifies that the respite care providers have passed a drug test and a background check.

4. The respite care coordination system of claim 1 wherein the server utilizes the contact information for the respite care provider to group the respite care provider into a geological region.

5. The respite care coordination system of claim 1 wherein users search the availability of the respite care services by searching for one of a group consisting of the respite care provider's name, a particular period of time, and a particular day.

6. The respite care coordination system of claim 1 wherein users search the availability of the respite care services by searching for the respite care provider's name.

7. The respite care coordination system of claim 1 wherein users search the availability of the respite care services by searching for a particular period of time.

8. The respite care coordination system of claim 1 wherein users search the availability of the respite care services by searching for a particular day.

9. A respite care coordination system comprising:
a respite care database adapted store data in one or more computer readable storage devices, the data including:
contact information for a respite care provider; and
available times that the respite care provider is available to provide respite care; and
a server computing device programmed to retrieve digital data from the database and to generate and transfer digital data across a network to user computing devices associated with users, wherein the digital data is configured to be interpreted by the user computing devices to display to the users an interactive web site, the web site prompting the respite care provider to enter their contact information and available times that the respite care provider is available to provide respite care services.

10. The respite care coordination system of claim 9 wherein the web site provides users with accessibility to search the available times that respite care services are available.

11. The respite care coordination system of claim 9 wherein users search the availability of the respite care services by searching for the respite care provider's name.

12. The respite care coordination system of claim 9 wherein users search the availability of the respite care services by searching for a particular period of time.

13. The respite care coordination system of claim 9 wherein users search the availability of the respite care services by searching for a particular day.

14. The respite care coordination system of claim 9 wherein the respite care coordination system is managed by an organizer that certifies the respite care providers.

15. The respite care coordination system of claim 9 wherein the organizer certifies that the respite care providers have passed a drug test and a background check.

16. A respite care coordination system comprising:
at least one computing device including at least one processing device; and
at least one computer readable storage device comprising data instructions, which when executed by the computing device cause the at least one computing device to generate:
a respite care database;
a registration engine that prompts a user for information relating to the user, receives the incoming data from the user and extracts the user information from the incoming data, identifies whether the user is a respite care provider, identifies the user information and its respective categories, stores the categorized user information in the respite care database;
a scheduling engine that prompts the respite care provider for availability information relating to the respite care provider's availability to perform respite care services, receives the incoming data from the user and extracts the availability information from the incoming data, identifying the availability information and its respective categories, stores the categorized availability information in the respite care database;
a membership engine that receives login credentials from the user, retrieves the user information, determines whether the primary care provider is an active member of the respite care coordination system, and permitting access to the respite care connection system if the primary care provider is an active or denying access to the respite care connection system if the primary care provider is inactive; and
a respite care connection engine that that prompts the user for search parameters for respite care services, receives the incoming data from the user and determines the category of the search parameter, query the respite care database for the search parameter, and presents the results to the user.

17. The respite care coordination system of claim 16 wherein search parameters for respite care services include a query for a particular day.

18. The respite care coordination system of claim 16 wherein search parameters for respite care services include a query for a particular respite care provider.

19. The respite care coordination system of claim 16 wherein users search the availability of the respite care services by searching for a particular day and start time.

20. The respite care coordination system of claim 16 wherein the at least one computing device includes a mobile device in communication with a respite care server.
